(19) United States
(12) Patent Application Publication
(10) Pub. No.: US 2015/0170422 A1
(43) Pub. Date: Jun. 18, 2015

(54) Information Display System With See-Through HMD, Display Control Program and Display Control Method

(71) Applicant: Konica Minolta, Inc., Tokyo (JP)

(72) Inventors: YASUFUMI AOYAMA, Tokyo (JP); MASAHIRO OZAWA, Tokyo (JP); HIROSHI NOGAWA, Tokyo (JP); KUNIKAZU SATOU, Tokyo (JP); TAKAHISA MATSUNAGA, Tokyo (JP); TETSUREN NOGAWA, Tokyo (JP); MITSUHARU HAYASAKA, Tokyo (JP)

(21) Appl. No.: 14/566,616

(22) Filed: Dec. 10, 2014

(30) Foreign Application Priority Data
Dec. 16, 2013 (JP) 2013-258978

(51) Int. Cl. G06T 19/00; G06T 11/20; G02B 27/01

(52) U.S. Cl. CPC G06T 19/006; G02B 27/017; G06T 11/20; G02B 2027/0178

(57) ABSTRACT

An information display system including a see-through head mount display including a display/projection unit configured to display a drawing object on a virtual screen in a state superimposed on surroundings, and a detection unit configured to detect information determining a position and/or an angle of the virtual screen relative to surroundings, wherein a controller includes: a drawing object generation unit configured to generate a drawing object on the basis of data generated by an application, refer to the information detected by the detection unit, set a drawing position of the drawing object on the virtual screen, and sets a drawing priority for each drawing object; and a drawing processing unit configured to control the display/projection unit to draw the drawing object at the drawing position on the virtual screen, and draws drawing objects overlapping with one another with priority given to a drawing object with a higher drawing priority.

The entire disclosure of Japanese Patent Application No. 2013-258978 filed on Dec. 16, 2013 including description, claims, drawings, and abstract are incorporated herein by reference in its entirety.

### BACKGROUND OF THE INVENTION

1. Field of the Invention

The present invention relates to an information display system, a control program, and a display control method, and in particular to an information display system with a see-through HMD, a display control program for controlling display of the see-through HMD, and a display control method for controlling display of the see-through HMD.

2. Description of the Related Art

In recent years, as devices such as sensors are being miniaturized, development of wearable, see-through HMDs (head mounted displays) called smart glasses and the like has been increasingly active. Typically, in an information display system using a see-through HMD, projecting and displaying a see-through virtual screen on a line of sight of a wearer (user) toward the surroundings allows the wearer (user) to check information while seeing the surroundings. In other words, one of the characteristics of see-through HMDs is to be capable of displaying information over the surroundings in the surrounding environment (superimposed display).

Furthermore, a see-through HMD may have mounted thereon sensors such as a GPS (global positioning system) sensor, a gyrosensor, and an acceleration sensor capable of detecting the viewpoint position and the direction of the line of sight (the orientation and the attitude in the horizontal/vertical directions) of the user in addition to a display device configured to projecting and displaying a virtual screen. When drawing information (referred to as drawing objects) such as characters, figures, and images is to be projected and displayed on a virtual screen, information (coordinates, an angle of orientation, an angle of elevation/an angle of depression, an attitude angle) detected by the sensors can be used to adjust drawing positions (including turning angles) of the drawing objects.

Regarding technologies for adjusting the drawing positions of drawing objects, JP 2012-160898 A discloses a technology of detecting a tilt angle of the head of an observer with respect to the direction of gravitational force, performing image tilt correction to correct a tilt of a camera image with respect to the direction of gravitational force in the direction opposite to the direction of the detected tilt angle and by a substantially equal angle, and displaying the camera image resulting from the image tilt correction as a monitor image on a screen of a monitor, for example.

There are mainly two types of drawing objects to be projected and displayed on a see-through HMD. One type of objects are objects that only make sense when displayed in a state superimposed on the surroundings (navigation information, for example). The drawing positions of these drawing objects on the virtual screen are preferably adjusted to the surroundings when the position (position and/or angle) of the virtual screen relative to the surroundings is changed. The other one type of objects are objects that is not relevant (less relevant) to the surroundings (video information such as a video phone, a moving picture and image information such as a map, for example). The drawing positions of these drawing objects are preferably adjusted to the virtual screen regardless of the position of the virtual screen relative to the surroundings.

When objects that are not relevant (less relevant) to the surroundings and objects that only make sense when displayed in a state superimposed on the surroundings are displayed on the virtual screen and if the drawing positions of the objects that are not relevant (less relevant) to the surroundings are changed by using the aforementioned technology of the related art, the drawing objects on the virtual screen may interfere with one another, and occurrence of overlap (interference) may result in loss of information, which is disadvantageous in that information cannot be properly provided to the user.

### SUMMARY OF THE INVENTION

The present invention has been made in view of the aforementioned problems, and a main object thereof is to provide an information display system with a see-through HMD capable of effectively reducing loss of information due to interference between drawing objects and a display control program.

To achieve the abovementioned object, according to an aspect, an information displaying system reflecting one aspect of the present invention comprises a see-through head mount display including a display/projection unit configured to display a drawing object on a virtual screen in a state superimposed on surroundings, and a detection unit configured to detect information determining a position and/or an angle of the virtual screen relative to surroundings, wherein a controller configured to control the head mount display includes: a drawing object generation unit configured to generate a drawing object on the basis of data generated by an application, refer to the information detected by the detection unit, and set a drawing position of the drawing object on the virtual screen; and a drawing processing unit configured to control the display/projection unit to draw the drawing object at the drawing position on the virtual screen, the drawing object generation unit sets a drawing priority for each drawing object according to a predetermined rule, and when the drawing positions of multiple drawing objects with different drawing priorities overlap with one another, the drawing processing unit draws the drawing objects with priority given to a drawing object with a higher drawing priority.

To achieve the abovementioned object, according to an aspect, a non-transitory recording medium storing a computer readable program that controls a display reflecting one aspect of the present invention runs on an information display system including a see-through head mount display including a display/projection unit configured to display a drawing object on a virtual screen in a state superimposed on surroundings, and a detection unit configured to detect information determining a position and/or an angle of the virtual screen relative to surroundings, and causes a controller configured to control the head mount display to execute: a drawing object generation process of generating a drawing object on the basis of data generated by an application, referring to the information detected by the detection unit, and setting a drawing position of the drawing object on the virtual screen; and a drawing process of controlling the display/projection unit to draw the drawing object at the drawing position on the virtual screen, wherein in the drawing object generation process, a drawing priority is set for each drawing object according to a predetermined rule, and in the drawing process, when the drawing positions of multiple drawing objects with different drawing priorities overlap with one another, the drawing objects are drawn with priority given to a drawing object with a higher drawing priority.

To achieve the abovementioned object, according to an aspect, a display control method reflecting one aspect of the present invention is carried out in an information display system including a see-through head mount display including a display/projection unit configured to display a drawing object on a virtual screen in a state superimposed on surroundings, and a detection unit configured to detect information determining a position and/or an angle of the virtual screen relative to surroundings, wherein a controller configured to control the head mount display executes: a drawing object generation process of generating a drawing object on the basis of data generated by an application, referring to the information detected by the detection unit, and setting a drawing position of the drawing object on the virtual screen; and a drawing process of controlling the display/projection unit to draw the drawing object at the drawing position on the virtual screen, in the drawing object generation process, a drawing priority is set for each drawing object according to a predetermined rule, and in the drawing process, when the drawing positions of multiple drawing objects with different drawing priorities overlap with one another, the drawing objects are drawn with priority given to a drawing object with a higher drawing priority.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIGS. 1A to 1C are diagrams schematically showing configurations of an information display system according to an embodiment of the present invention;

FIGS. 2A and 2B are block diagrams schematically showing a configuration of the information display system according to the embodiment of the present invention;

FIGS. 3A and 3B are diagrams showing an example in which drawing objects overlap with one another as a result of a change in the orientation of the line of sight;

FIGS. 4A and 4B are diagrams showing an example in which drawing objects overlap with one another as a result of a change in the tilt of the line of sight;

FIG. 5 is a diagram schematically showing an outline of processing in the information display system according to the embodiment of the present invention;

FIG. 6 is a flowchart showing processing (a drawing object generation process) in the information display system according to the embodiment of the present invention;

FIG. 7 is a flowchart showing processing (a drawing process) in the information display system according to the embodiment of the present invention;

FIG. 8 is a flowchart showing processing (another example of the drawing process) in the information display system according to the embodiment of the present invention;

FIGS. 9A and 9B are diagrams for explaining an example of a display control method for a virtual screen according to the embodiment of the present invention;

FIGS. 10A and 10B are diagrams for explaining another example of the display control method for a virtual screen according to the embodiment of the present invention;

FIGS. 11A to 11C are diagrams showing variations (examples of reducing the size and changing the shape of a drawing object with a low drawing priority) in the display control method for a virtual screen according to the embodiment of the present invention;

FIGS. 12A to 12C are diagrams showing variations (examples of dividing and partially deleting a drawing object with a low drawing priority) in the display control method for a virtual screen according to the embodiment of the present invention;

FIGS. 13A to 13C are diagrams showing variations (examples of adjusting the transparency (brightness or density) of a drawing object) in the display control method for a virtual screen according to the embodiment of the present invention; and

FIGS. 14A to 14C are diagrams showing variations (examples of enhancing display of a drawing object with a high drawing priority) in the display control method for a virtual screen according to the embodiment of the present invention.

### DESCRIPTION OF THE PREFERRED EMBODIMENTS

Hereinafter, an embodiment of the present invention will be described with reference to the drawings. However, the scope of the invention is not limited to the illustrated examples.

As stated in the Description of the Related Art, a wearable, see-through HMD can display information (drawing objects) over a virtual screen in a state superimposed on the surroundings (superimposed display), which allows the wearer (user) to check various information data while seeing the surroundings. The drawing objects displayed on the virtual screen, however, include objects that only make sense when displayed in a state superimposed on the surroundings and objects that are not relevant (less relevant) to the surroundings. When both drawing objects are present and if the drawing position of one of the drawing objects is changed according to the viewpoint position or the orientation of the line of sight of the user (the position of the virtual screen relative to the surroundings), the drawing objects may overlap with each other, which causes loss of information.

Specifically, if the position of the virtual screen relative to the surroundings is changed, a drawing object that only makes sense when displayed in a state superimposed on the surroundings needs to be changed in a direction opposite to that of the change of the virtual screen (so that the position relative to the surroundings is maintained). In contrast, a drawing object that is not relevant (less relevant) to the surroundings needs to be changed with a change of the virtual screen regardless of the change in the position of the virtual screen relative to the surroundings (so that the position relative to the virtual screen is maintained). Thus, when both drawing objects are present and if the drawing position of one of the drawing objects is changed, the drawing objects on the virtual screen overlap with each other and information of one or both of the drawing objects is lost at the overlapping portion.

Thus, in an embodiment of the present invention, the drawing position of a drawing object on a virtual screen is set on the basis of position information and angle information detected by a detection unit such as a GPS sensor, a gyrosensor, and an acceleration sensor, it is determined whether or not each drawing object is an object whose drawing position on the virtual screen needs to be adjusted according to the viewpoint position and the line of sight orientation of the user (the position of the virtual screen relative to the surroundings), and drawing priority is set for the drawing object according to the determination result. For drawing the drawing objects on the virtual screen on the basis of the set drawing positions, it is then determined whether an overlap of multiple drawing objects with different drawing priorities overlap occurs, and if an overlap of multiple objects occurs, an interference avoidance process of giving priority to drawing of a drawing object with a higher drawing priority on the basis of the drawing priorities and changing the state in which the drawing object is displayed so that the visibility of the object is ensured is performed. For example, the drawing position of a drawing object with a lower drawing priority may be moved, the drawing object with a lower drawing priority may be reduced in size, changed in shape, or divided, an overlapping portion thereof may be deleted, or the transparency thereof may be increased (the brightness or the density thereof may be decreased). Furthermore, the transparency of a drawing object with a higher drawing priority may be decreased (the brightness or the density thereof may be increased, or display of the drawing object with a higher drawing priority may be enhanced by enlargement or blinking. As a result, loss of information can be effectively reduced and proper information can be presented to the user.

### Embodiment

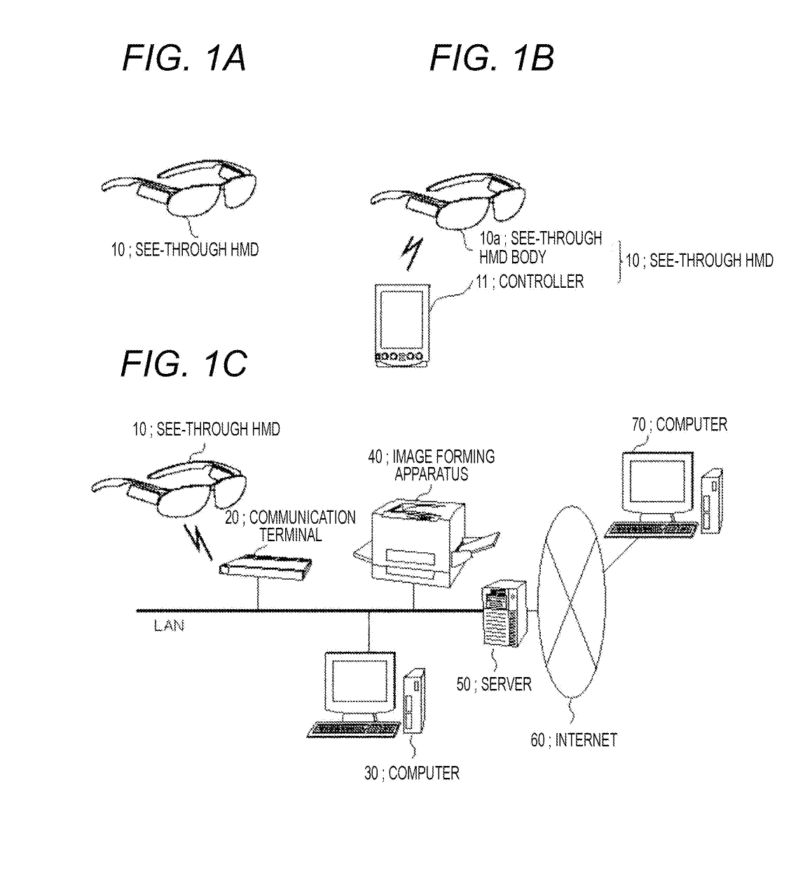

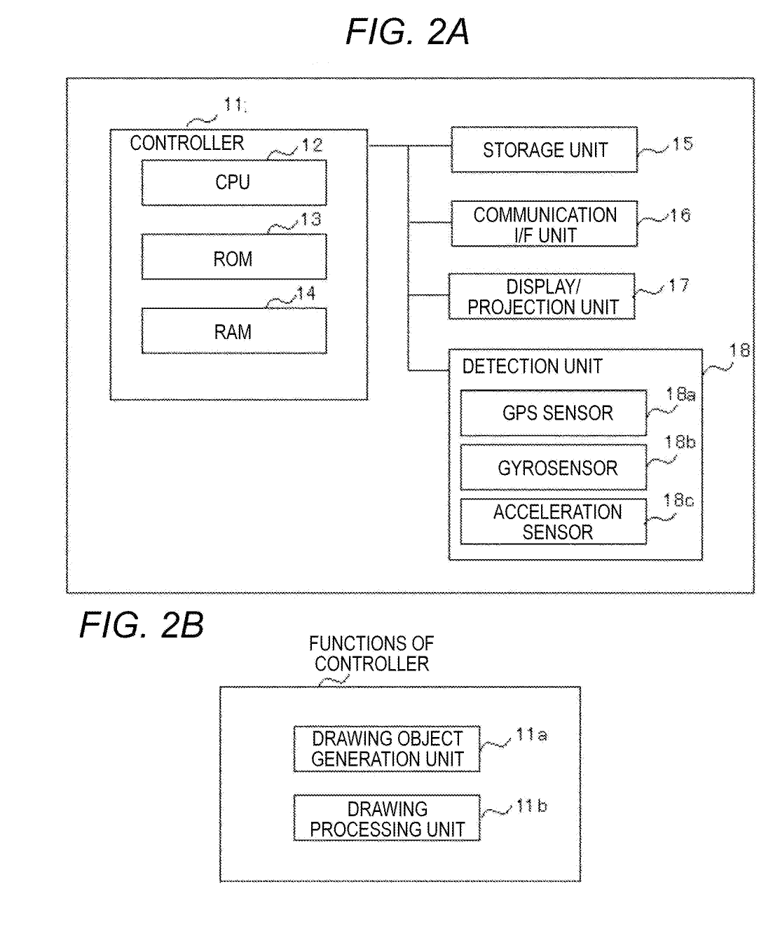

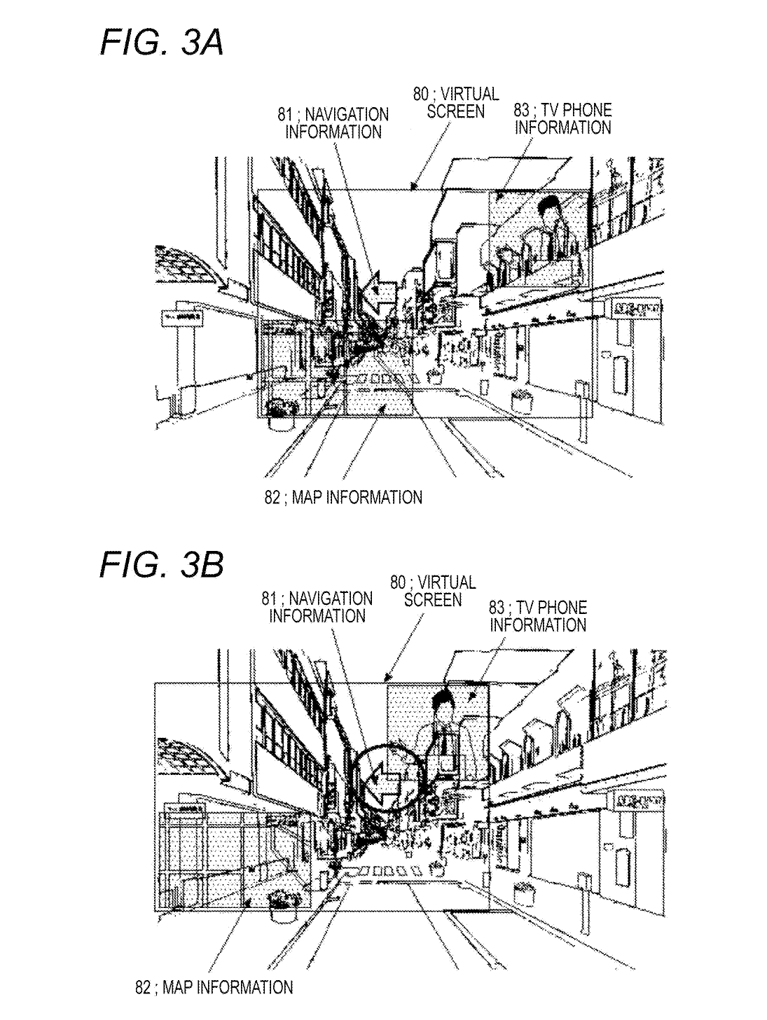

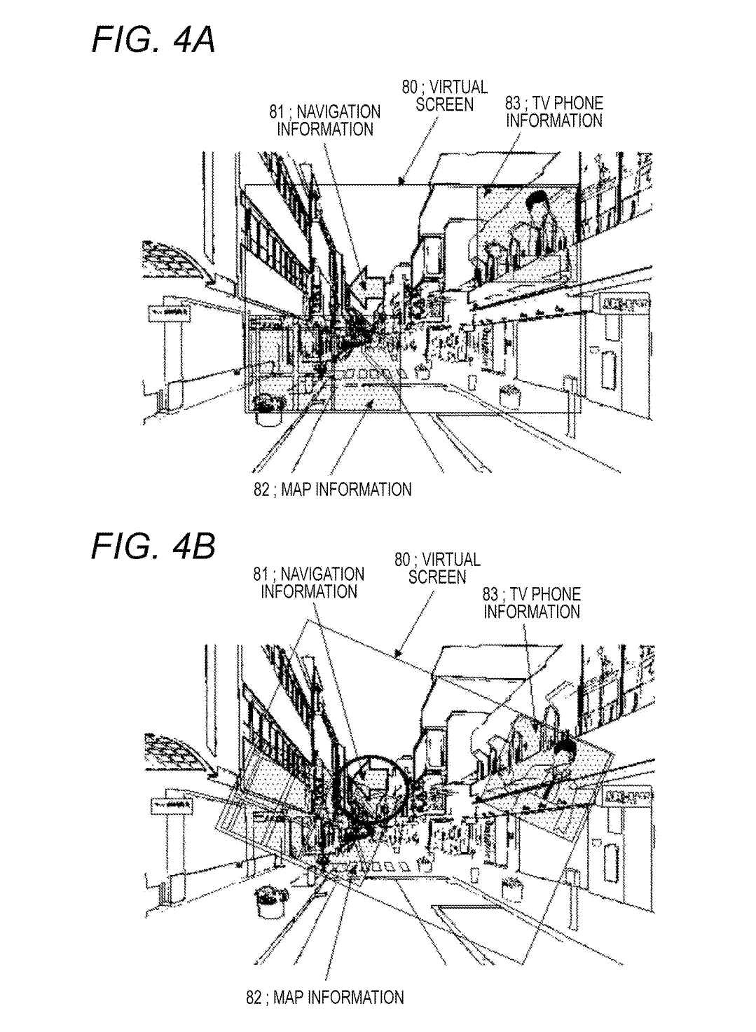

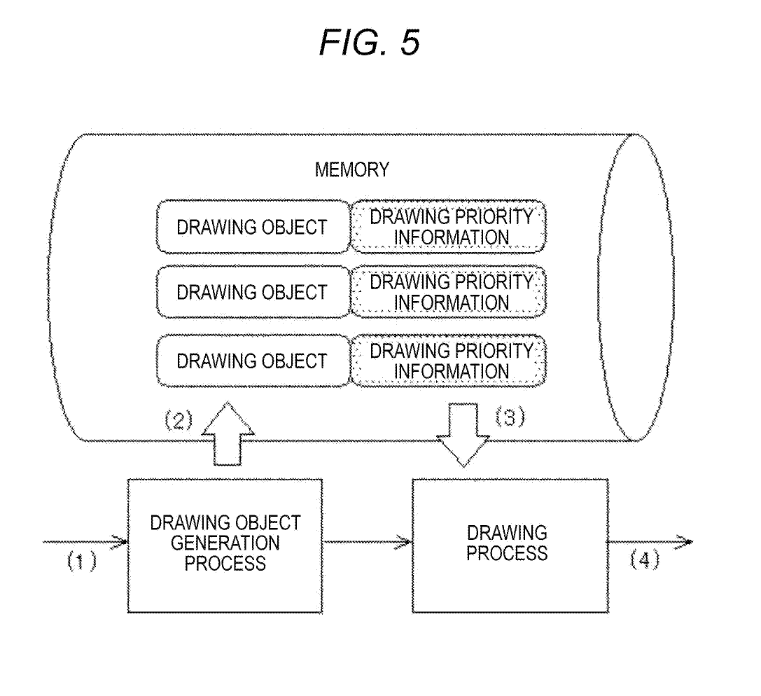

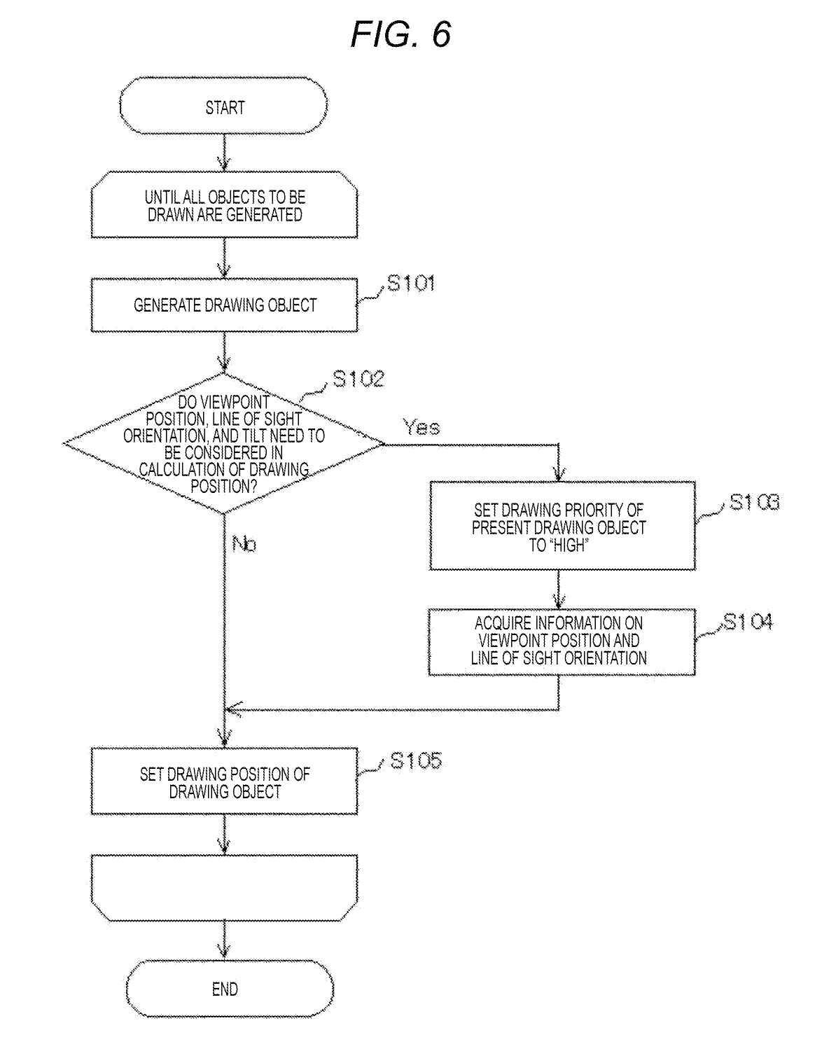

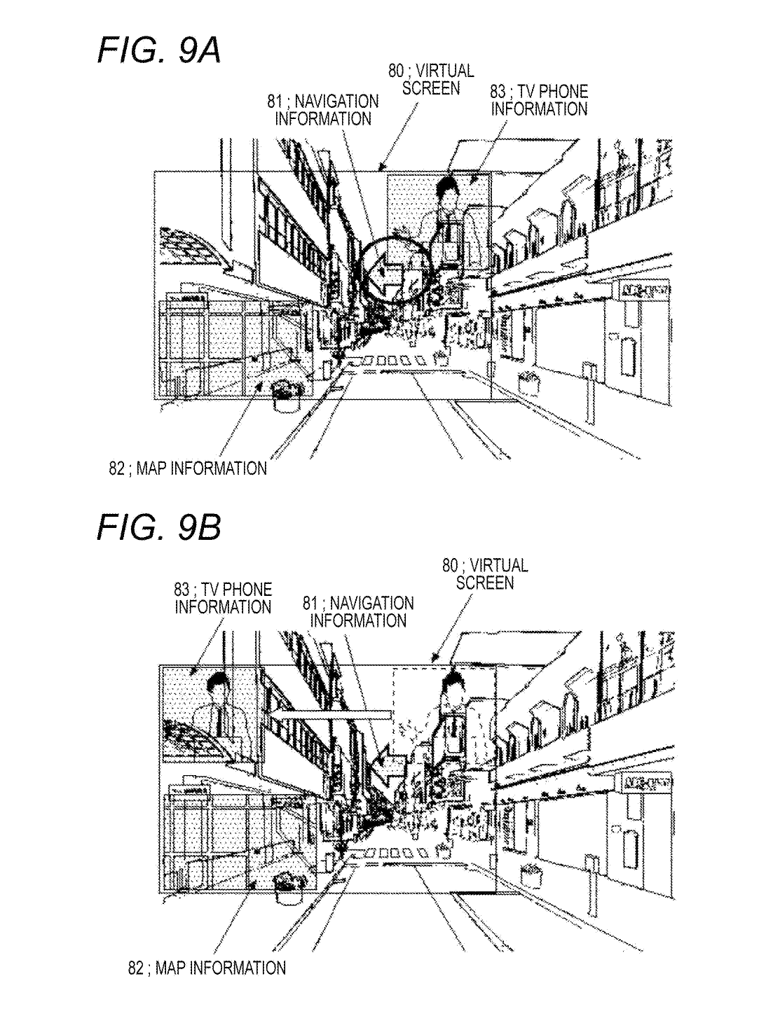

To explain the embodiment of the present invention described above in more detail, an information display system with a see-through HMD and a display control program according to an embodiment of the present invention will be described with reference to FIGS. 1A to 14C. FIGS. 1A to 1C are diagrams schematically showing configurations of the information display system according to the embodiment, and FIGS. 2A and 2B are block diagrams showing a configuration of the information display system. FIGS. 3A, 3B, 4A and 4B are diagrams explaining problems when drawing objects overlap with one another, and FIG. 5 is a diagram schematically showing an outline of processing in the information display system according to the embodiment. Furthermore, FIGS. 6 to 8 are flowcharts showing processing in the information display system according to the embodiment, and FIGS. 9A to 14C are diagrams showing examples of a display control method for a virtual screen.

The information display system according to the embodiments is a system including a see-through HMD 10, and may have various configurations. A typical configuration is a configuration in which the see-through HMD 10 is stand-alone as shown in FIG. 1A or a configuration in which the see-through HMD 10 is divided into a body 10a of the see-through HMD 10 and a controller 11, which are connected through wired or wireless connection as shown in FIG. 1B. When drawing objects to be displayed on a virtual screen of the see-through HMD 10 are generated, edited, or used in another device, a configuration in which the see-through HMD 10, a communication terminal 20, a computer 30 configured to generate and edit drawing objects, and an image forming apparatus 40 configured to print drawing objects and transmit drawing objects via facsimile are connected via a network can be used as shown in FIG. 1C. Furthermore, a configuration in which a server 50 is provided in the network and connected to a computer 70 or the like in an external network via the Internet 60 may be used.

The networks may be of any type, and the communication terminal 20, the computer 30, the image forming apparatus 40, and the server 50 in the configuration of FIG. 1C can be connected by a LAN (local area network) or the like defined by a standard such as the Ethernet (registered trademark), the FDDI (fiber-distributed data interface), or a token ring. The network of the see-through HMD 10 and the external network can be connected by using the Internet connection, a public facsimile line, or the like. The see-through HMD 10 may be connected to the network via a mobile communication channel such as LTE (Long Term Evolution)/3G or a radio communication channel such as WiMAX. Furthermore, short-range radio communication defined by a standard such as Bluetooth (registered trademark), NFC (Near Field Communication), TransferJet, Wibree, or IrDA may be used for communication between the body 10a of the see-through HMD 10 and the controller 11 in the configuration of FIG. 1B and communication between the see-through HMD 10 and the communication terminal 20 in the configuration of FIG. 1C.

Hereinafter, the see-through HMD 10 that is a characteristic feature of the information display system according to the embodiment will be described in detail. Although the description of the embodiment will be made on the assumption of the configuration of FIG. 1A (the configuration in which the see-through HMD 10 is stand-alone), drawing objects may alternatively be acquired from the external controller 11 (in the configuration of FIG. 1B), the computers 30 and 70 or the server 50 (in the configuration of FIG. 1C).

The information display system of the embodiment is integrated with a member (such as glasses, sunglasses, goggles, or a cap) worn by a user, and includes the controller 11, a storage unit 15, a communication interface (I/F) unit 16, a display/projection unit 17, a detection unit 18, and the like as shown in FIG. 2A.

The controller 11 includes a CPU (central processing unit) 12, and memories such as a ROM (read only memory) 13, and a RAM (random access memory) 14, and is fixed or placed inside or outside of a housing (such as temples of glasses, sunglasses or goggles) of the see-through HMD 10. The CPU 12 reads out a control program for controlling operation of the see-through HMD 10 (an application for generating data from which drawing objects are produced where necessary) or the like from the ROM 13 or the storage unit 15, expands and executes the program in the RAM 14. The controller also functions as a drawing object generation unit 11a, a drawing processing unit 11b, and the like as shown in FIG. 2B.

The drawing object generating unit 11a generates a drawing object on the basis of data generated by using an application. The drawing object generating unit 11a then determines whether or not the drawing object is an object whose drawing position on the virtual screen needs to be adjusted according to the viewpoint position and the line of sight orientation of the user (that is, the position and/or the angle (positional relation) of the virtual screen relative to the surroundings) for calculating the drawing position on the virtual screen, sets a drawing priority according to the determination result, adds information of the drawing priority to the data of the drawing object, and stores the resulting data in a memory. In the present specification, the line of sight orientation is a concept including the orientation (azimuth) in the horizontal direction, the orientation in the vertical direction, and the attitude (tilt). The drawing position on the virtual screen is a concept including the top, bottom, left, and right positions of the virtual screen and the angle of the virtual screen with respect to a reference line.

Whether or not a drawing object is an object whose drawing position on the virtual screen needs to be adjusted can be determined according to what application is used to generate data on the basis of which the drawing object is generated, for example, and the drawing priority can be set according to the type of the application.

Specifically, a drawing object based on data generated by an application for conducting navigation such as guidance or an application for providing information relating to a location or buildings needs to be drawn in relation to the surroundings and is therefore determined to be an object whose drawing position on the virtual screen needs to be adjusted according to the viewpoint position and the light of sight orientation, and the drawing priority therefor is set to “high.” A drawing object based on data generated by an application for TV phone, television broadcast, moving picture reproduction, or the like is not relevant (or less relevant) to the surroundings, and is therefore determined to be an object whose drawing position on the virtual screen need not be adjusted according to the viewpoint position and the line of sight orientation, and the drawing priority therefor is set to “low.” Furthermore, a drawing object based on data generated by an application for providing a map or an application for providing images from stationary cameras, or the like is relevant to the surroundings but display thereof need not be changed with each change in the viewpoint position and the line of sight orientation and is therefore determined to be an object whose drawing position on the virtual screen need not be adjusted according to the viewpoint position and the light of sight orientation, and the drawing priority therefor is set to “low” (or “medium”).

Note that the drawing priority can be set according to which sensor (or how many types of sensors) in the detection unit 18, which will be described later, detects the information to be used. For example, the drawing priority can be set to “high” for an object such as navigation information where information detected by a GPS sensor and a gyrosensor, and, where necessary, an acceleration sensor is used, the drawing priority can be set to “medium” for an object such as map information where only information detected by a GPS sensor is used, and the drawing priority can be set to “low” for an object such as TV phone information where information detected by sensors need not be used.

The drawing object generation unit 11a also acquires information on the viewpoint position and the line of sight orientation on the basis of signals detected by the detection unit 18 (position information detected by the GPS sensor, and angle information such as an angle of orientation, an angle of elevation/an angle of depression, and an attitude angle detected by the gyrosensor and the acceleration sensor), which will be described later. If the drawing object is a drawing object whose drawing position on the virtual screen needs to be adjusted according to the viewpoint position and the line of sight orientation, the drawing object generation unit 11a then sets the drawing position of the drawing object on the virtual screen on the basis of the acquired information on the viewpoint position and the line of sight orientation drawing object on the virtual screen, and informs the drawing processing unit 11b of the set drawing position information.

Specifically, when coordinates of a real space projected onto the virtual screen are represented by (x, y, z), coordinates of projection onto a specific position (upper-left position, for example) before the viewpoint position and the line of sight orientation (orientations in the horizontal/vertical directions) are changed are represented by (x1, y1, z1), and coordinates of projection onto the same specific position on the virtual screen after the viewpoint position and the line of sight orientation are changed are represented by (x2, y2, z2), the drawing object on the virtual screen is moved by (x1-x2, y1-y2, z1-z2) (that is, moved to be overlaid on the same position of the surroundings). Furthermore, when the virtual screen is turned by θ with respect to the angle of the virtual screen before the line of sight orientation (attitude) is changed, the drawing object on the virtual screen is turned by −θ (that is, turn so that the tilt with respect to the surroundings remains unchanged).

When the drawing object is a drawing object whose drawing position on the virtual screen need not be adjusted according to the viewpoint position and the line of sight orientation, the drawing position with respect to the virtual screen is not changed.

The drawing processing unit 11b acquires the data of the drawing object and the information on the drawing position from a memory, and controls the display/projection unit 17 to display the drawing object on the drawing position of the virtual screen. In this process, the drawing processing unit 11b determines whether an overlap between a drawing object (referred to as a first object) whose drawing position on the virtual screen needs to be adjusted according to the viewpoint position and the line of sight orientation and a drawing object (referred to as a second object) whose drawing position on the virtual screen need not be adjusted according to the viewpoint position and the line of sight orientation is caused, and if an overlap is caused, changes the state of display of the second object (or the first object) so that the visibility of the first object can be ensured.

Specifically, the second object is moved to a position that does not overlap with the first object, reduced in size, changed in shape or divided so as not to overlap with the first object, display of a portion overlapping with the first object is deleted, or the transparency thereof is increased (the brightness or the density thereof is decreased). Alternatively, the transparency of the first object is decreased (the brightness of the density thereof is increased), or the first object is enhanced by being enlarged or made to blink.

Note that the drawing object generation unit 11a and the drawing processing unit 11b may be implemented by hardware, or may be implemented as a display control program that makes the controller 11 function as the drawing object generation unit 11a and the drawing processing unit 11b and the display control program may be executed by the CPU 12. In the case of the configuration of FIG. 1C, the display control program may be caused to run on the computer 30 or 70, the server 50, or the like.

The storage unit 15 is an SSD (solid state drive), an SD (secure digital) card, or the like fixed or placed inside or outside of a housing (such as temples of glasses, sunglasses or goggles) of the see-through HMD 10, and stores data generated by applications, data of drawing objects to be displayed on the virtual screen, setting information for specifying display areas on the virtual screen, a table for determining whether each drawing object is a drawing object whose drawing position on the virtual screen needs to be adjusted according to the viewpoint position and the line of sight orientation, and the like.

The communication I/F unit 16 is an NIC (network interface card) or a modem, is fixed or placed inside or outside of a housing (such as temples of glasses, sunglasses or goggles) of the see-through HMD 10, and carries out communication with external devices through wireless LAN communication, mobile communication, near field radio communication, or the like described above. When the see-through HMD 10 need not communicate with external devices (for example, when data are transmitted and received to/from external devices via an SD card), the communication I/F unit 16 may be omitted. When the see-through HMD 10 is divided into the see-through HMD body 10a and the controller 11, each of the see-through HMD body 10a and the controller 11 may be provided with a communication I/F unit 16 and the controller 11 may control the see-through HMD body 10a via both of the communication I/F units 16.

The display/projection unit 17 is a display device or a projection device for displaying an image of a drawing object onto the virtual screen on the basis of the data of the drawing object received from the controller 11. Examples of the method for displaying an object include a display method in which a display unit itself is transmissive and a drawing object is displayed on the display unit and a projection method in which information is projected onto a transmissive member. In the display method, an image of a drawing object is displayed on the virtual screen by placing a transmissive liquid crystal display device or the like on a surface of lenses or glass of glasses, sunglasses, or goggles, driving the liquid crystal display device by a driving circuit fixed or placed on the housing of the see-through HMD 10 to display the drawing object. In the projection method, an image of a drawing object is displayed on the virtual screen by placing a projection device on endpieces of glasses, sunglasses or goggles, and projecting the drawing object onto lenses or glass.

The detection unit 18 includes sensors (such as a GPS sensor 18a, a gyrosensor 18b, and an acceleration sensor 18c) configured to detect the viewpoint position and the line of sight orientation, and is fixed or placed inside or outside of the housing (such as temples of glasses, sunglasses or goggles) of the see-through HMD 10. The GPS sensor 18a detects coordinates of the see-through HMD 10 in the real space on the basis of GPS information received from a GPS satellite. The gyrosensor 18b detects a change in the angle (an angular velocity) from a reference direction of the see-through HMD 10. The acceleration sensor 18c detects acceleration of the see-through HMD 10 and detects the attitude of the see-through HMD 10 on the basis of the gravitational acceleration.

Note that FIGS. 2A and 2B show an example of the see-through HMD 10 of the embodiment, and the configuration thereof and the display control method can be modified as appropriate as long as the drawing position of a drawing object on the virtual screen can be corrected on the basis of the viewpoint position and the line of sight orientation. For example, although FIGS. 2A and 2B show a configuration in which the user wearing the see-through HMD 10 changes the viewpoint position and the line of sight orientation by moving his/her face, the user can the viewpoint position and the line of sight orientation moving his/her eyes without moving the see-through HMD 10. In this case, a camera for capturing the positions of pupils of the user's eyes may be can be provided to determine the viewpoint position and the line of sight orientation of the user from the pupil positions.

Hereinafter, drawing objects to be displayed on the virtual screen will be specifically described with reference to the drawings.

FIG. 3A is a diagram schematically showing field-of-view information of the user wearing the see-through HMD 10. A frame displayed in a state superimposed on the surroundings corresponds to a display area of a virtual screen 80 of the see-through HMD 10. On the virtual screen 80, navigation information 81 (an arrow showing a guidance direction in this example), map information 82, and TV phone information 83 (an image of the other party in this example), for example, are displayed as drawing objects. Among the drawing objects, the navigation information 81 is a drawing object (first object) whose drawing position on the virtual screen needs to be adjusted according to the viewpoint position and the line of sight orientation, the map information 82 and the TV phone information 83 are drawing objects (second objects) whose drawing positions on the virtual screen need not be adjusted according to the viewpoint position and the line of sight orientation.

FIG. 3B shows a case in which the user has turned the face horizontally from the state of FIG. 3A and the line of sight orientation (that is, the orientation of the see-through HMD 10) is moved to the left. In this case, since the map information 82 and the TV phone information 83 are drawing objects whose drawing positions on the virtual screen 80 need not be adjusted according to the viewpoint position and the line of sight orientation, the drawing positions are moved to the left with the frame of the virtual screen 80 (that is, the drawing positions on the virtual screen 80 are not changed). In contrast, since the navigation information 81 is a drawing object whose drawing position on the virtual screen needs to be adjusted according to the viewpoint position and the line of sight orientation and which needs to be superimposed on the same position of the surroundings, the drawing position is not moved with the movement of the frame of the virtual screen (that is, the drawing position on the virtual screen 80 is moved to the right).

FIG. 4B shows a case in which the user has turned the face from the state of FIG. 4A and the see-through HMD 10 is turned in the clockwise direction. In this case, since the map information 82 and the TV phone information 83 are drawing objects whose drawing positions on the virtual screen 80 need not be adjusted according to the viewpoint position and the line of sight orientation similarly to the above, the drawing positions are turned in the clockwise direction with the frame of the virtual screen 80 (that is, the drawing positions on the virtual screen 80 are not changed). In contrast, since the navigation information 81 is a drawing object whose drawing position on the virtual screen 80 needs to be adjusted according to the viewpoint position and the line of sight orientation and which needs to be oriented in the same direction with respect to the surroundings, the navigation information 81 is not turned with the turning of the frame of the virtual screen 80 (that is, the drawing position on the virtual screen 80 is turned in the counterclockwise direction).

Since the drawing positions of the map information 82 and the TV phone information 83 relative to the virtual screen 80 are not changed and the drawing position of the navigation information 81 relative to the virtual screen 80 changes in this manner, an overlap between the drawing objects (the navigation information 81 and the TV phone information 83 in FIG. 3B, the navigation information 81 and the map information 82 in FIG. 4B) may be caused and the drawing information may be lost, which degrades the visibility of the drawing objects.

Thus, in the embodiment, the following processing is performed to prevent loss of important drawing information due to interference (overlap) between the drawing objects.

Specifically, as shown in FIG. 5, in a drawing object generation process for generating a drawing object to be displayed on the virtual screen 80, data generated by an application is acquired, a drawing object is generated (see (1) in FIG. 5), it is determined whether or not the generated drawing object is an object whose drawing position on the virtual screen needs to be adjusted according to the viewpoint position and the line of sight orientation, and drawing priority information according to the determination result is added to the data of the drawing object and stored in the memory (see (2) in FIG. 5). Subsequently, in a drawing process, the drawing objects to which the drawing priority information is added are acquired from the memory (see (3) in FIG. 5), and if the drawing position of a drawing object overlap with that of another drawing object with a higher drawing priority, an interference avoidance process is performed before drawing the drawing objects on the virtual screen 80 (see (4) in FIG. 5) to prevent loss of information due to interference between the drawing objects.

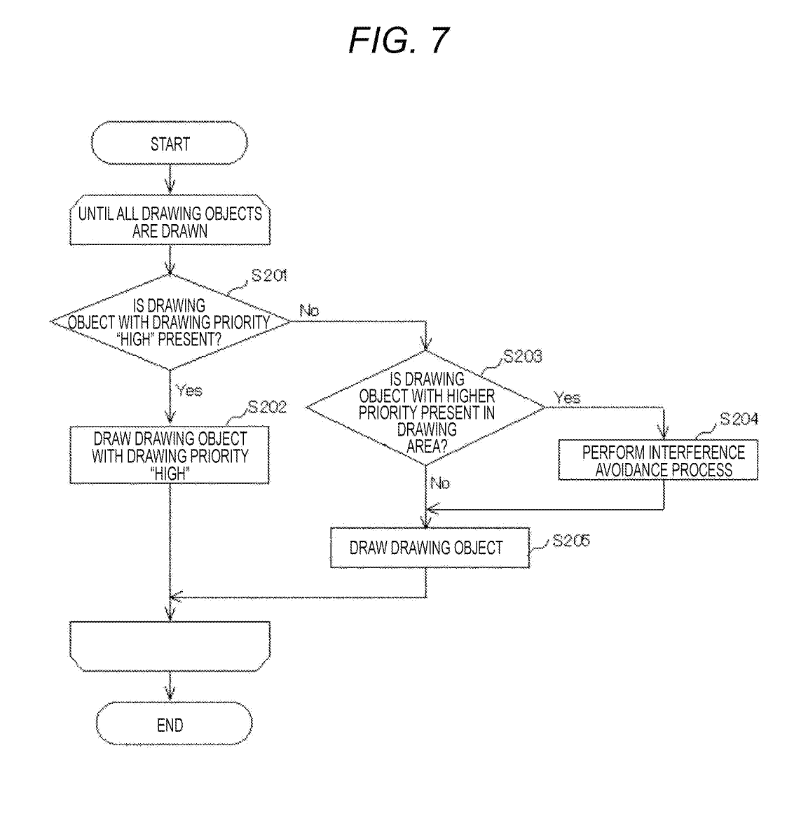

Hereinafter, specific processing of the information display system (see-through HMD 10) will be described. The CPU 12 reads a display control program stored in the ROM 13 or the storage unit 15, and expands and executes the display control program in the RAM 14 to executes processing in the respective steps shown in the flowcharts of FIGS. 7 to 9. In the following flows, it is assumed that a table for determining whether or not each drawing object is a drawing object whose drawing position on the virtual screen needs to be adjusted according to the viewpoint position and the line of sight orientation is generated in advance and stored in the storage unit 15 or the like.

[Drawing Object Generation Process]

First, the controller 11 (the drawing object generation unit 11a) generates a drawing object to be displayed/projected on the virtual screen on the basis of data generated by an application (S101).

Subsequently, for calculating the drawing position of the generated drawing object on the virtual screen, the controller 11 (the drawing object generation unit 11a) refers to the table stored in advance and determines whether the drawing object is a drawing object whose drawing position on the virtual screen needs to be adjusted according to the viewpoint position and the line of sight orientation of the user (S102).

For a drawing object whose drawing position on the virtual screen needs to be adjusted according to the viewpoint position and the line of sight orientation of the user, the drawing priority of the drawing object is set to “high,” the drawing priority information is added to the data of the drawing object and stored in the memory (S103), and information on the viewpoint position and line of sight orientation is acquired from the detection unit 18 (the GPS sensor 18a, the gyrosensor 18b, and the acceleration sensor 18c) (S104). Although the drawing priority is set only for a drawing object whose drawing position on the virtual screen according to the viewpoint position and the line of sight orientation in the present flow, the drawing priority may be set to “low” for a drawing object whose drawing position on the virtual screen need not be adjusted. Furthermore, the drawing priority is not limited to two levels of “high” and “low,” but may be set to three levels such as “high,” “medium” and “low” or more.

Subsequently, the controller 11 (the drawing object generation unit 11a) sets the drawing position of the drawing object on the virtual screen (S105). For example, for a drawing object whose drawing position on the virtual screen needs to be adjusted according to the viewpoint position and the line of sight orientation, the position on the virtual screen over a predetermined position in the surroundings (such as an intersection to be guide to for a drawing object based on data generated by an application for navigation) is set. For a drawing object whose drawing position on the virtual screen need not be adjusted according to the viewpoint position and the line of sight orientation, a specific position on the virtual screen (such as a lower-left position for a drawing object based on data generated by an application for a map and an upper-right position for a drawing object based on data generated by an application for TV phone) is set.

The controller 11 (the drawing object generation unit 11a) then repeats the processing in S101 to S105 until all the objects to be drawn are generated.

[Drawing Process]

The controller 11 (the drawing processing unit 11b) determines whether or not a drawing object with the drawing priority “high” is present in the drawing objects generated through the above flow on the basis of the drawing priority information added to the data of drawing objects stored in the memory (S201).

If a drawing object with the drawing priority “high” is present in the drawing objects to be drawn (Yes in S201), the controller 11 (the drawing processing unit 11b) retrieves the data of the drawing object with the drawing priority “high” from the memory, and controls the display/projection unit 17 to draw the drawing object at the drawing position on the virtual screen set in S105 of the above flow (S202).

If no drawing object with the drawing priority “high” is present in the drawing objects to be drawn (No in S201), the controller 11 (the drawing processing unit 11b) retrieves data of a drawing object with a drawing priority other than “high,” and determines whether or not a drawing object with a higher drawing priority is present in the drawing area of the drawing object (that is, whether a drawing object with the drawing priority “high” is already drawn) (S203). If a drawing object with a higher drawing priority is present, an interference avoidance process (details of which will be described later) for avoiding loss of information caused by an overlap of drawing objects is performed (S204). If no drawing object with a higher drawing priority is present, the controller 11 (the drawing processing unit 11b) draws the drawing object at the drawing position on the virtual screen set in S105 of the above flow (S205).

The controller 11 (the drawing processing unit 11b) then repeats the processing in S201 to S205 until all the drawing objects are drawn.

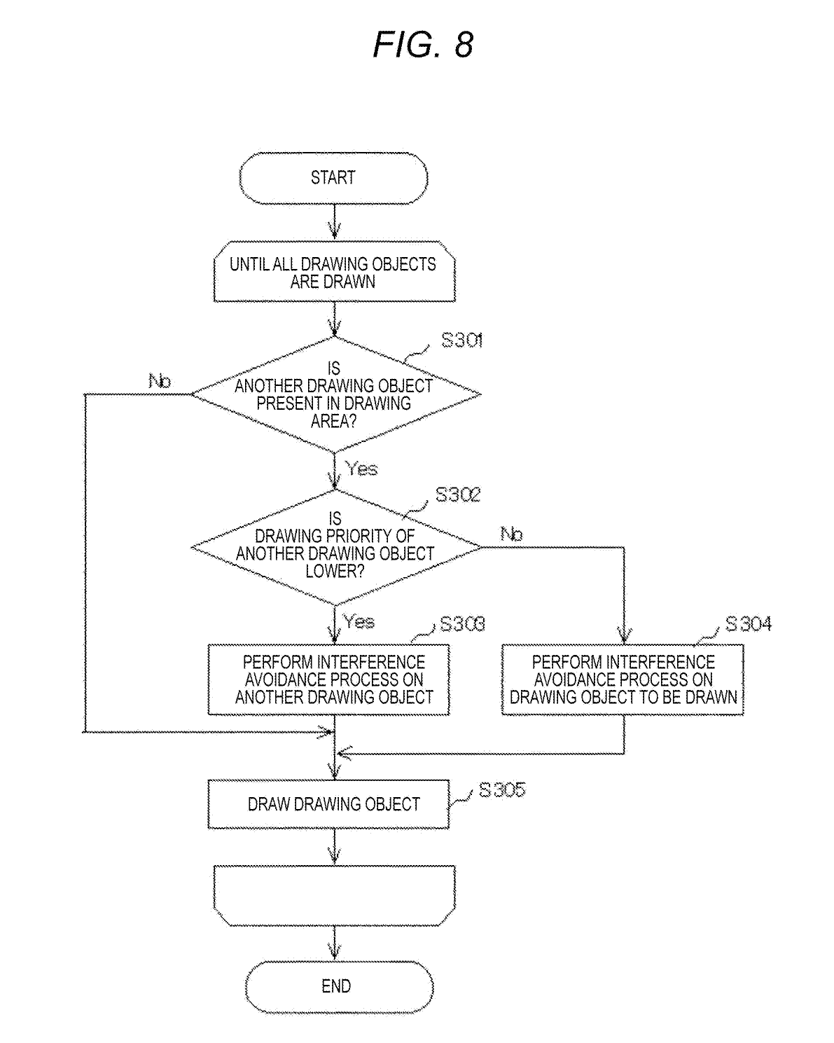

Although the above flow in an example in which a drawing object with a higher priority is drawn first, the drawing objects may be sequentially drawn. In this case, as shown in FIG. 8, the data of drawing objects are sequentially retrieved from the memory, it is determined whether or not a drawn drawing object is already present at the drawing position of a drawing object to be drawn (S301), and if a drawn drawing object is already present, it is determined whether the drawing priority of the drawn drawing object is lower (S302). If the drawing priority of the drawn drawing object is lower (Yes in S302), the interference avoidance process is performed on the drawn drawing object (S303). If the drawing priority of the drawn drawing object is higher (and if the drawing priorities of the drawing objects are equal where appropriate), the interference avoidance process is performed on the drawing object to be drawn (S304). Subsequently, the drawing object is drawn at the drawing position on the virtual screen (S305), and the processing in S301 to S305 is repeated until all the drawing objects are drawn.

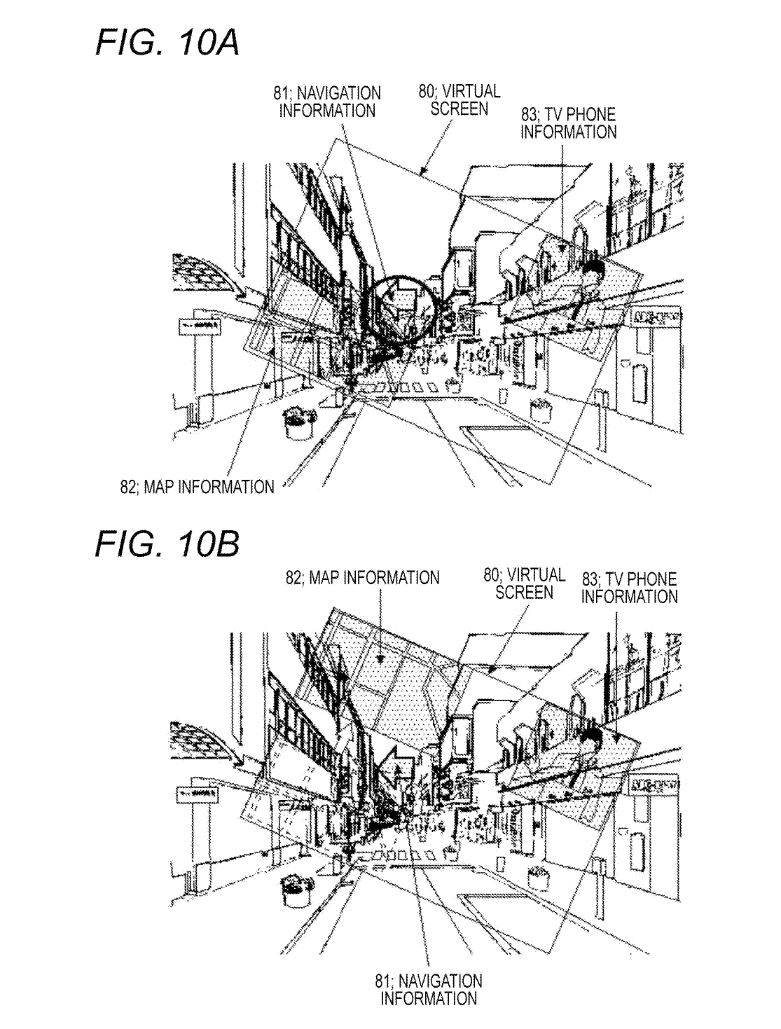

Next, the “interference avoidance process” mentioned above will be specifically described with reference to the drawings. FIG. 9A shows an example in which the navigation information 81 and the TV phone information 83 interfere with each other as a result of a change in the line of sight orientation (the orientation in the horizontal direction) of the user (the state in FIG. 3B). In this case, the drawing processing unit 11b gives priority to drawing of the navigation information 81 with a higher drawing priority as shown in FIG. 9B, and performs control to move the TV phone information 83 with a lower drawing priority to a position (from the upper-right position to the upper-left position on the virtual screen in this example) where the TV phone information 83 does not interfere with the navigation information 81. FIG. 10A shows an example in which the navigation information 81 and the TV map information 82 interfere with each other as a result of a change in the line of sight orientation (the attitude) of the user (the state in FIG. 4B). In this case, the drawing processing unit 11b gives priority to drawing of the navigation information 81 with a higher drawing priority as shown in FIG. 10B, and performs control to move the map information 82 with a lower drawing priority to a position (from the lower-left position to the upper-left position on the virtual screen in this example) where the map information 82 does not interfere with the navigation information 81.

As a result of performing such an interference avoidance process as giving priority to drawing of a drawing object with a higher drawing priority and moving a drawing object with a lower drawing priority to a position where interference is not caused in this manner, the visibility of the drawing object with the higher drawing priority can be ensured and loss of important information can be effectively prevented.

Although examples in which a drawing object with a lower drawing priority is moved to a position where interference is not caused are shown as the interference avoidance process in FIGS. 9A, 9B, 10A and 10B, the interference avoidance process may be any process capable of avoiding loss of information caused by an overlap of drawing objects.

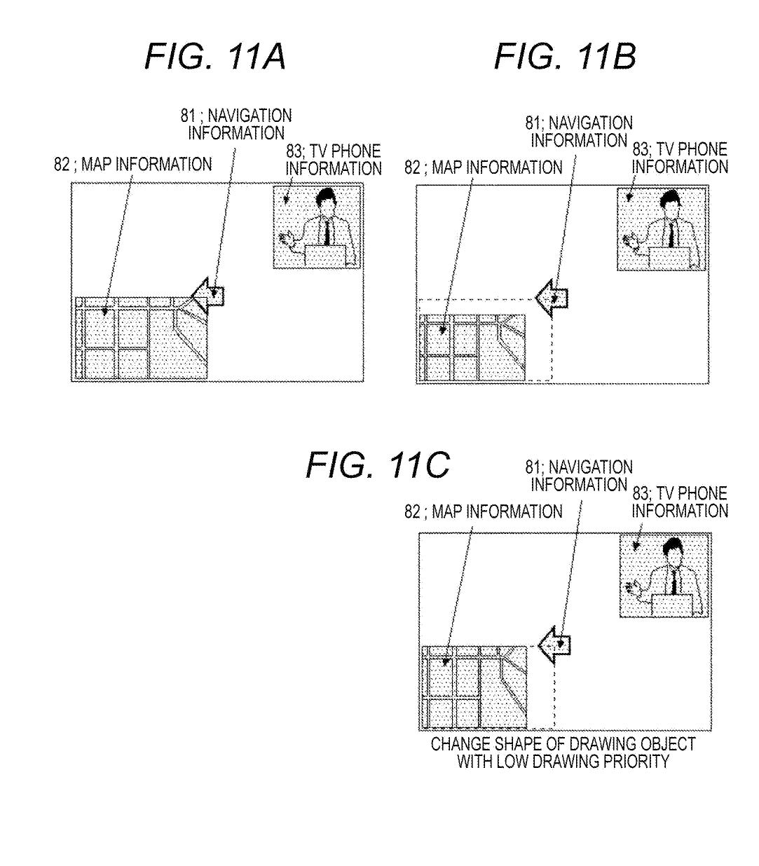

For example, when an overlap of drawing positions of multiple drawing objects with different drawing priorities is caused as shown in FIG. 11A, the drawing object (the map information 82 in this example) with the lower drawing priority may be reduced in size as shown in FIG. 11B or the shape of the drawing object with the lower drawing priority may be changed as shown in FIG. 11C to avoid loss of information of the drawing object (the navigation information 81 in this example) with the higher drawing priority.

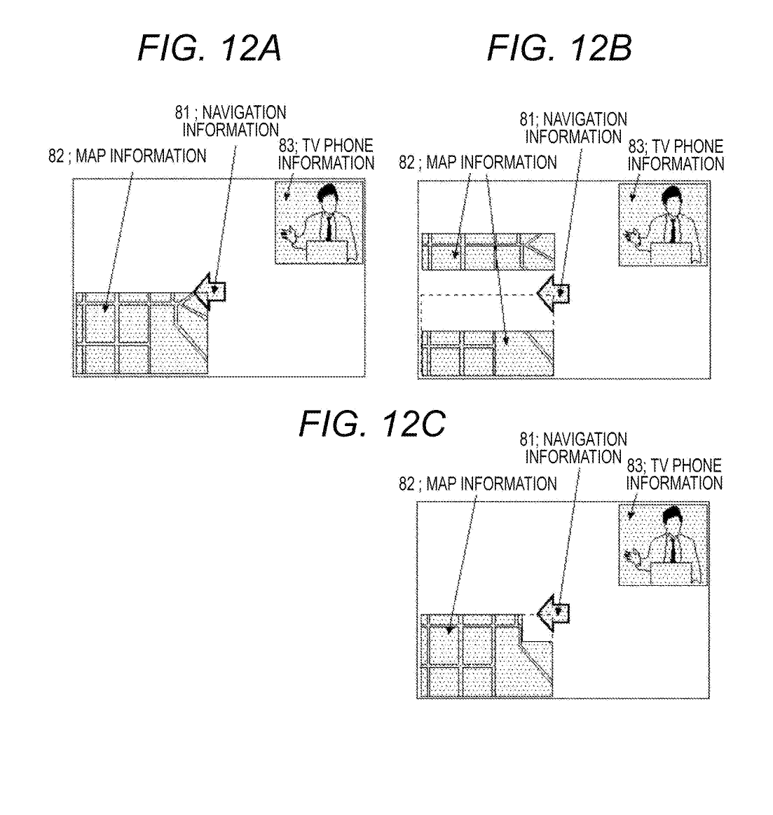

Similarly, when an overlap of drawing positions of multiple drawing objects with different drawing priorities is caused as shown in FIG. 12A, the drawing object with the lower drawing priority may be divided as shown in FIG. 12B or display of the overlapping portion of the drawing object with the lower drawing priority may be deleted as shown in FIG. 12C to avoid loss of information of the drawing object with the higher drawing priority.

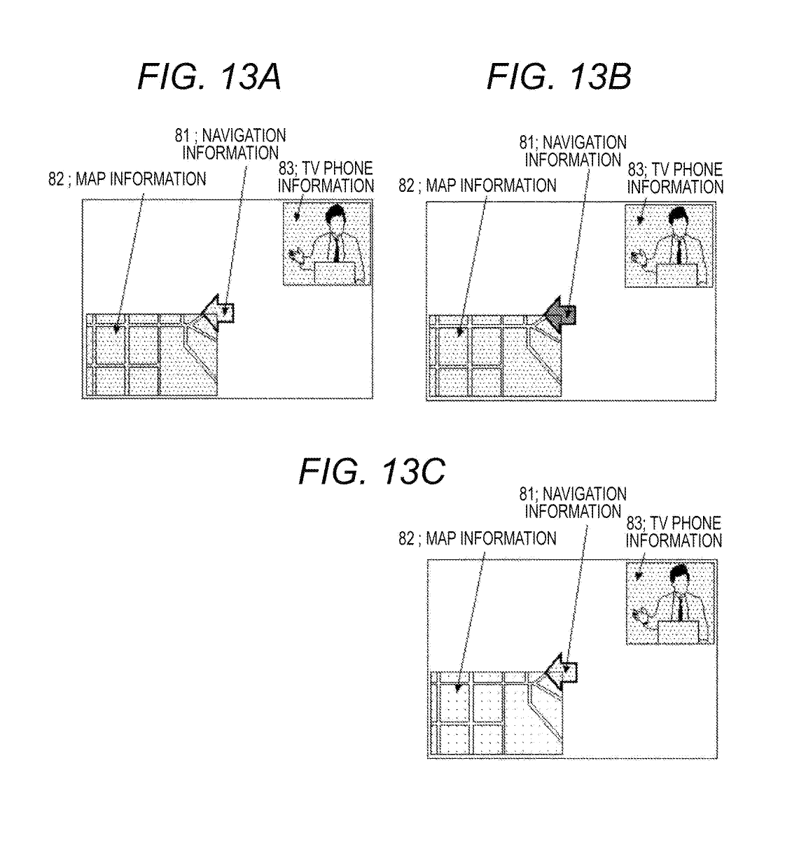

Alternatively, when an overlap of drawing positions of multiple drawing objects with different drawing priorities is caused as shown in FIG. 13A, the transparency of the drawing object with the higher drawing priority may be decreased (that is, the brightness and the density thereof may be increased) as shown in FIG. 13B or the transparency of the drawing object with the lower drawing priority may be increased (that is, the brightness and the density thereof may be increased) as shown in FIG. 13C to increase the visibility of the drawing object with the higher drawing priority. In the drawings, the transparency is expressed by the density of hatching.

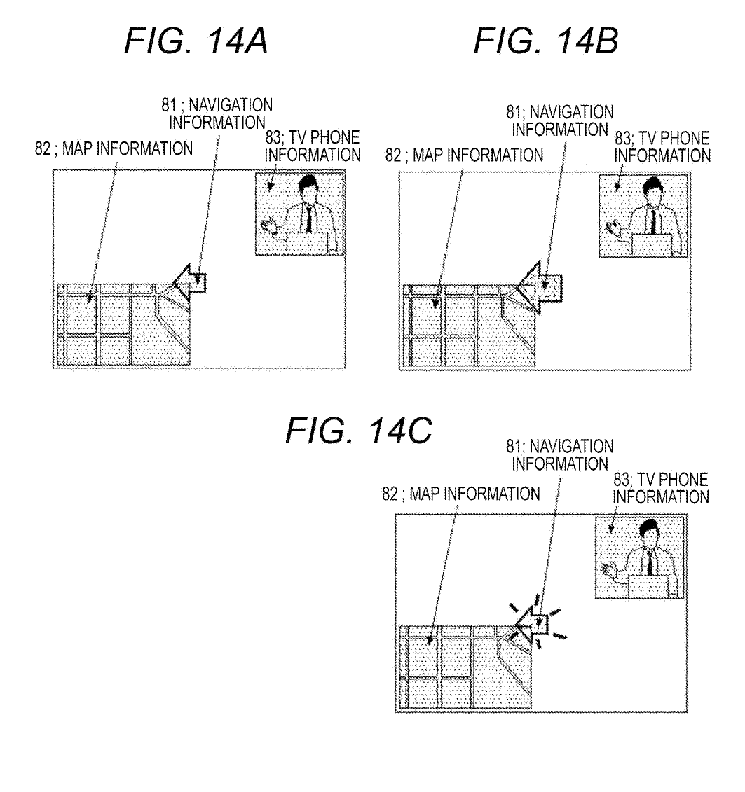

Alternatively, when an overlap of drawing positions of multiple drawing objects with different drawing priorities is caused as shown in FIG. 14A, the drawing object with the higher drawing priority may be enhanced by being enlarged as shown in FIG. 14B or the drawing object with the higher drawing priority may be enhanced by blinking as shown in FIG. 14C to improve the visibility of the drawing object with the higher drawing priority.

Note that the present invention is not limited to the embodiment described above, but the configuration of the see-through HMD 10 and the display control method can be modified as appropriated without departing from the scope of the present invention.

For example, although examples in which the interference avoidance process is performed on one of the drawing object with the lower drawing priority and the drawing object with the higher drawing priority are presented in the embodiment described above, the interference avoidance process may be performed on both of the drawing objects.

Furthermore, although examples of processing such as reduction in size, change of shape, division, partial deletion, and increase in transparency on a drawing object with a lower drawing priority and processing such as enlargement, blinking, and decrease in transparency on a drawing object with a higher drawing priority are presented as the interference avoidance process in the embodiment described above, the interference avoidance process may be any process capable of ensuring the visibility of one of multiple drawing objects with different drawing priorities, and the examples of the processing may be combined in any manner.

Furthermore, when an object is displayed on lenses or glass of glasses, sunglasses or goggles by using the display/projection unit 17, the object may be displayed on both left and right lenses or glasses or on only one of the left and right lenses or glasses.

Furthermore, although a wearable see-through HMD 10 integrated with glasses, sunglasses, goggles, a cap, or the like is described in the embodiment described above, the display control method of the embodiment can similarly be applied to a device (such as a see-through HUD) fixed to an apparatus.

The present invention can be applied to an information display system with a see-through HMD, a display control program for controlling display of an object of the see-through HMD, and a recording medium recording the display control program.

Although the present invention has been described and illustrated in detail, it is clearly understood that the same is by way of illustrated and example only and is not to be taken by way of limitation, the scope of the present invention being interpreted by terms of the appended claims.

What is claimed is:

1. An information display system comprising a see-through head mount display including a display/projection unit configured to display a drawing object on a virtual screen in a state superimposed on surroundings, and a detection unit configured to detect information determining a position and/or an angle of the virtual screen relative to surroundings, wherein
a controller configured to control the head mount display includes:
a drawing object generation unit configured to generate a drawing object on the basis of data generated by an application, refer to the information detected by the detection unit, and set a drawing position of the drawing object on the virtual screen; and
a drawing processing unit configured to control the display/projection unit to draw the drawing object at the drawing position on the virtual screen,
the drawing object generation unit sets a drawing priority for each drawing object according to a predetermined rule, and
when the drawing positions of multiple drawing objects with different drawing priorities overlap with one another, the drawing processing unit draws the drawing objects with priority given to a drawing object with a higher drawing priority.

2. The information display system according to claim 1, wherein the drawing object generation unit classifies each of the drawing objects as a first object whose drawing position on the virtual screen is to be changed so that the position relative to the surroundings is maintained when the position and/or the angle of the virtual screen relative to the surroundings are changed or a second object whose drawing position on the virtual screen is not to be changed when the position and/or the angle of the virtual screen relative to the surroundings are changed, and sets the drawing priority of the first object higher than that of the second object.

3. The information display system according to claim 1, wherein the drawing object generation unit sets the drawing priority of each of the drawing objects on the basis of the type of the application.

4. The information display system according to claim 1, wherein
the detection unit includes multiple types of sensors configured to detect different information data, and
the drawing object generation unit sets the drawing priority higher as the number of types of information data referred to for generating the drawing object is larger.

5. The information display system according to claim 1, wherein the detection unit includes one or more of a GPS (global positioning system) sensor, a gyrosensor, and an acceleration sensor.

6. The information display system according to claim 1, wherein the drawing processing unit performs, on a drawing object with a lower drawing priority among multiple drawing objects whose drawing positions overlap with one another, one or more processes selected from a process of moving to a position where the drawing object does not overlap with a drawing object with a higher drawing priority, a process of reduction in size, change in shape or division so as not to overlap with the drawing object with the higher drawing priority, a process of deleting display of a portion overlapping with the drawing object with the higher drawing priority, and a process of increasing transparency.

7. The information display system according to claim 1, wherein the drawing processing unit performs, on a drawing object with a higher drawing priority among multiple drawing objects whose drawing positions overlap with one another, one or more processes selected from a process of enlargement, a process of blinking, and a process of decreasing transparency.

8. A non-transitory recording medium storing a computer readable program that controls a display and runs on an information display system including a see-through head mount display including a display/projection unit configured to display a drawing object on a virtual screen in a state superimposed on surroundings, and a detection unit configured to detect information determining a position and/or an angle of the virtual screen relative to surroundings,
the display control program causing a controller configured to control the head mount display to execute:
a drawing object generation process of generating a drawing object on the basis of data generated by an application, referring to the information detected by the detection unit, and setting a drawing position of the drawing object on the virtual screen; and
a drawing process of controlling the display/projection unit to draw the drawing object at the drawing position on the virtual screen, wherein
in the drawing object generation process, a drawing priority is set for each drawing object according to a predetermined rule, and
in the drawing process, when the drawing positions of multiple drawing objects with different drawing priorities overlap with one another, the drawing objects are drawn with priority given to a drawing object with a higher drawing priority.

9. The non-transitory recording medium storing a computer readable program that controls a display according to claim 8, wherein in the drawing object generation process, each of the drawing objects is classified as a first object whose drawing position on the virtual screen is to be changed so that the position relative to the surroundings is maintained when the position and/or the angle of the virtual screen relative to the surroundings are changed or a second object whose drawing position on the virtual screen is not to be changed when the position and/or the angle of the virtual screen relative to the surroundings are changed, and the drawing priority of the first object is set higher than that of the second object.

10. The non-transitory recording medium storing a computer readable program that controls a display according to claim 8, wherein in the drawing object generation process, the drawing priority of each of the drawing objects is set on the basis of the type of the application.

11. The non-transitory recording medium storing a computer readable program that controls a display according to claim 8, wherein
the detection unit includes multiple types of sensors configured to detect different information data, and
in the drawing object generation process, the drawing priority is set higher as the number of types of information data referred to for generating the drawing object is larger.

12. The non-transitory recording medium storing a computer readable program that controls a display according to claim 8, wherein the detection unit includes one or more of a GPS sensor, a gyrosensor, and an acceleration sensor.

13. The non-transitory recording medium storing a computer readable program that controls a display according to claim 8, wherein in the drawing process, one or more processes selected from a process of moving to a position where the drawing object does not overlap with a drawing object with a higher drawing priority, a process of reduction in size, change in shape or division so as not to overlap with the drawing object with the higher drawing priority, a process of deleting display of a portion overlapping with the drawing object with the higher drawing priority, and a process of increasing transparency is performed on a drawing object with a lower drawing priority among multiple drawing objects whose drawing positions overlap with one another.

14. The non-transitory recording medium storing a computer readable program that controls a display according to claim 8, wherein in the drawing process, one or more processes selected from a process of enlargement, a process of blinking, and a process of decreasing transparency is performed on a drawing object with a higher drawing priority among multiple drawing objects whose drawing positions overlap with one another.

15. A display control method in an information display system including a see-through head mount display including a display/projection unit configured to display a drawing object on a virtual screen in a state superimposed on surroundings, and a detection unit configured to detect information determining a position and/or an angle of the virtual screen relative to surroundings, wherein
a controller configured to control the head mount display executes:
a drawing object generation process of generating a drawing object on the basis of data generated by an application, referring to the information detected by the detection unit, and setting a drawing position of the drawing object on the virtual screen; and
a drawing process of controlling the display/projection unit to draw the drawing object at the drawing position on the virtual screen,
in the drawing object generation process, a drawing priority is set for each drawing object according to a predetermined rule, and
in the drawing process, when the drawing positions of multiple drawing objects with different drawing priorities overlap with one another, the drawing objects are drawn with priority given to a drawing object with a higher drawing priority.

16. The display control method according to claim 15, wherein in the drawing object generation process, each of the drawing objects is classified as a first object whose drawing position on the virtual screen is to be changed so that the position relative to the surroundings is maintained when the position and/or the angle of the virtual screen relative to the surroundings are changed or a second object whose drawing position on the virtual screen is not to be changed when the position and/or the angle of the virtual screen relative to the surroundings are changed, and the drawing priority of the first object is set higher than that of the second object.

17. The display control method according to claim 15, wherein in the drawing object generation process, the drawing priority of each of the drawing objects is set on the basis of the type of the application.

18. The display control method according to claim 15, wherein
the detection unit includes multiple types of sensors configured to detect different information data, and
in the drawing object generation process, the drawing priority is set higher as the number of types of information data referred to for generating the drawing object is larger.

19. The display control method according to claim 15, wherein the detection unit includes one or more of a GPS sensor, a gyrosensor, and an acceleration sensor.

20. The display control method according to claim 15, wherein in the drawing process, one or more processes selected from a process of moving to a position where the drawing object does not overlap with a drawing object with a higher drawing priority, a process of reduction in size, change in shape or division so as not to overlap with the drawing object with the higher drawing priority, a process of deleting display of a portion overlapping with the drawing object with the higher drawing priority, and a process of increasing transparency is performed on a drawing object with a lower drawing priority among multiple drawing objects whose drawing positions overlap with one another.

21. The display control method according to claim 15, wherein in the drawing process, one or more processes selected from a process of enlargement, a process of blinking, and a process of decreasing transparency is performed on a drawing object with a higher drawing priority among multiple drawing objects whose drawing positions overlap with one another.
